(19) United States
(12) Patent Application Publication
(10) Pub. No.: US 2014/0046864 A1
(43) Pub. Date: Feb. 13, 2014

(54) Virtual Funding Campaign Methodology

(71) Applicant: Kiindly, LLC, Bingham Farms, MI (US)

(72) Inventors: Ivan Frank, Bloomfield, MI (US); Adam Valentine, Chicago, IL (US); Derek Croft, Bloomfield, MI (US); Nathan Sarlow, Farmington Hills, MI (US)

(21) Appl. No.: 13/828,599

(22) Filed: Mar. 14, 2013

Related U.S. Application Data
(60) Provisional application No. 61/681,721, filed on Aug. 10, 2012.

(51) Int. Cl. G06Q 30/02

(52) U.S. Cl. CPC G06Q 30/0279
USPC 705/329

(57) ABSTRACT

A virtual funding campaign method is disclosed. The method includes: executing instructions on a computing processor to electronically display a graphical user interface; receiving first pledge data of a first funder from at least one displayed field of the graphical user interface; receiving additional pledge data from at least one second funder from the at least one displayed field of the graphical user interface; modifying the first pledge data as a result of receiving the additional pledge data from the at least one second funder; after the modifying step, tabulating a pledge amount for the first funder that is related to the modified first pledge data; and electronically communicating the tabulated pledge amount to the first funder. A virtual funding campaign system is also disclosed. A computer program product encoded on a non-transitory computer readable storage medium comprising instructions that when executed by a data processing apparatus cause the data processing apparatus to perform operations is also disclosed.

### CROSS-REFERENCE TO RELATED APPLICATIONS

This U.S. patent application claims priority to U.S. Provisional Application: 61/681,721 filed on Aug. 10, 2012, the disclosure of which is considered part of the disclosure of this application and is hereby incorporated by reference in its entirety.

### TECHNICAL FIELD

The disclosure relates to a virtual funding campaign methodology.

### BACKGROUND

The World Wide Web provides the ability to transmit and receive information electronically. Because of the World Wide Web, a new form of commerce called “electronic commerce” or “e-commerce” was born.

E-commerce rendered obsolete, or, in the alternative, has contributed to a significant improvement over traditional methodologies of conducting commerce. Thus, it may be said that e-commerce has provided a significant contribution to the arts by increasing efficiencies. Although e-commerce has resulted in increased efficiencies, improvements are nevertheless continuously being sought in order to advance the art.

### DESCRIPTION OF THE DRAWINGS

The disclosure will now be described, by way of example, with reference to the accompanying drawings, in which:

FIG. 1 is a view of an exemplary system for conducting a virtual funding campaign methodology.

FIG. 2 illustrates an exemplary method for initializing pledge data associated with a virtual funding campaign methodology.

FIG. 3 illustrates an exemplary method for conducting a virtual funding campaign methodology.

FIG. 4 illustrates an exemplary a browser displaying public web-page content associated with the system for conducting the virtual funding campaign methodology of FIG. 1.

FIG. 5 illustrates an exemplary a browser displaying public web-page content associated with the system for conducting the virtual funding campaign methodology of FIG. 1.

### SUMMARY

One aspect of the invention provides virtual funding campaign method. The virtual funding campaign method includes: executing instructions on a computing processor to electronically display a graphical user interface; receiving first pledge data of a first funder from at least one displayed field of the graphical user interface; receiving additional pledge data from at least one second funder from the at least one displayed field of the graphical user interface; modifying the first pledge data as a result of receiving the additional pledge data from the at least one second funder; after the modifying step, tabulating a pledge amount for the first funder that is related to the modified first pledge data; and electronically communicating the tabulated pledge amount of the first funder.

In some implementations, the method includes electronically communicating cash handling instructions from a first funder financial account to a funding campaign financial account based on the tabulated pledge amount.

In some examples, the method includes storing the first pledge data and the additional pledge data in memory.

In some instances, the method includes retrieving first pledge data and the additional pledge data from memory to generate the tabulated pledge amount for the first funder.

In some implementations, the first pledge data includes first pledge amount data.

In some examples, the first pledge data further includes pledge cap amount data.

In some instances, the modifying step includes limiting an increase of the first pledge amount data to the pledge cap amount data as a result of receiving at least the additional pledge data from the at least one second funder.

In some implementations, the method includes providing pledge increment amount data.

In some examples, the modifying step includes incrementing the first pledge amount data by the pledge increment amount data as a result of receiving the additional pledge data from the at least one second funder.

In some instances, the additional pledge data from the at least one second funder includes pledge amount data.

Another aspect of the invention provides virtual funding campaign system. The virtual funding campaign system includes a graphical user interface having one or more fields displayed on an electronic display for: receiving first pledge data of a first funder from at least one displayed field of the graphical user interface and receiving additional pledge data from at least one second funder from the at least one displayed field of the graphical user interface. The virtual funding campaign system also includes a computing processor for modifying the first pledge data as a result of receiving the additional pledge data from the at least one second funder, and, after the modifying step, tabulating a pledge amount for the first funder that is related to the modified first pledge data and electronically communicating the tabulated pledge amount of the first funder.

In some implementations, the computing processor electronically communicates cash handling instructions from a first funder financial account to a funding campaign financial account based on the tabulated pledge amount.

In some examples, memory stores the first pledge data and the additional pledge data.

In some instances, the computing processor retrieves first pledge data and the additional pledge data from memory and generates the tabulated pledge amount for the first funder.

In some implementations, the first pledge data includes first pledge amount data.

In some examples, the first pledge data further includes pledge cap amount data.

In some instances, the computing processor limits an increase of the first pledge amount data to the pledge cap amount data as a result of receiving at least the additional pledge data from the at least one second funder.

In some implementations, the method includes providing pledge increment amount data.

In some examples, the computing processor increments the first pledge amount data by the pledge increment amount data as a result of receiving the additional pledge data from the at least one second funder.

In some instances, the additional pledge data from the at least one second funder includes pledge amount data.

In yet another aspect of the disclosure provides a computer program product encoded on a non-transitory computer readable storage medium comprising instructions that when executed by a data processing apparatus cause the data processing apparatus to perform operations comprising: executing instructions on a computing processor to electronically display a graphical user interface; receiving first pledge data of a first funder from at least one displayed field of the graphical user interface; receiving additional pledge data from at least one second funder from the at least one displayed field of the graphical user interface; modifying the first pledge data as a result of receiving the additional pledge data from the at least one second funder; after the modifying step, tabulating a pledge amount for the first funder that is related to the modified first pledge data; and electronically communicating the tabulated pledge amount of the first funder.

In some implementations, the method includes electronically communicating cash handling instructions from a first funder financial account to a funding campaign financial account based on the tabulated pledge amount.

In some examples, the method includes storing the first pledge data and the additional pledge data in memory.

In some instances, the method includes retrieving first pledge data and the additional pledge data from memory to generate the tabulated pledge amount for the first funder.

In some implementations, the first pledge data includes first pledge amount data.

In some examples, the first pledge data further includes pledge cap amount data.

In some instances, the modifying step includes limiting an increase of the first pledge amount data to the pledge cap amount data as a result of receiving at least the additional pledge data from the at least one second funder.

In some implementations, the method includes providing pledge increment amount data.

In some examples, the modifying step includes incrementing the first pledge amount data by the pledge increment amount data as a result of receiving the additional pledge data from the at least one second funder.

In some instances, the additional pledge data from the at least one second funder includes pledge amount data.

### DETAILED DESCRIPTION

The figures illustrate an exemplary implementation of a virtual funding campaign methodology. Based on the foregoing, it is to be generally understood that the nomenclature used herein is simply for convenience and the terms used to describe the invention should be given the broadest meaning by one of ordinary skill in the art.

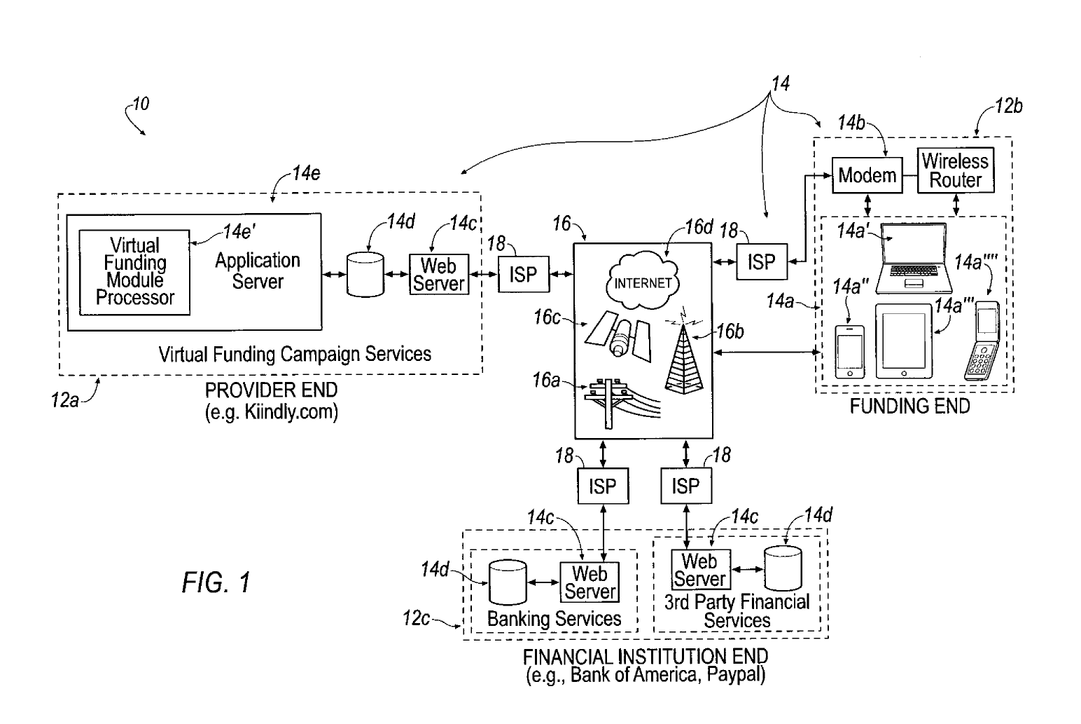

FIG. 1 illustrates an exemplary implementation of a system, which is shown generally at 10. The system 10 yields a virtual funding campaign methodology provided from a provider end 12a (e.g., www.kiindly.com) that is utilized by one or more funders (e.g., “Funder A,” “Funder B” . . . “Funder n”) at a funder end 12b.

The virtual funding campaign methodology performed by the system 10 may be directed to any type of non-profit or for-profit virtual funding campaign. For example, the virtual funding campaign methodology may be directed to a non-profit, revenue-generating charitable cause (e.g., a charity); as a result, the one or more funders may be referred to as one or more “donors.” In another example, the virtual funding campaign methodology may be directed to a for-profit, revenue-generating entity (e.g., a business, company, or the like); as a result, the one or more funders may be referred to as one or more “investors.”

Irrespective of the non-profit or for-profit implementation of the virtual funding campaign methodology, as will be described in the following disclosure, the virtual funding campaign methodology may operate on the principle of “compounding matching funders;” that is, a funder (e.g., “Funder A”) may act as a return contributor to the virtual funding campaign by provisionally agreeing to increase his/her pledged funding amount on the condition that other funders (e.g., “Funder B,” “Funder B+1,” etc.) also participate in the virtual funding campaign. By employing the principle of “compounding matching donors,” the system 10 overcomes funding challenges (such as, e.g., “free-rider syndrome”) that have been documented in empirical research. As a result, the system 10 thereby encourages the sharing of funding opportunities among a community of funders while communicating quality of the funding opportunities to the community of funders; the resulting “crowd based fund matching methodology” employed by the system 10 improves the efficacy and efficiency of funding commerce for non-profit and for-profit organizations.

In some implementations, the system 10 may further comprise one or more additional ends (see, e.g., 12c) that may communicate with one or more of the provider end 12a and the funder end 12b. The one or more additional ends may include, but are not limited to: a financial institution end 12c or the like. The financial institution end 12c may include a bank (e.g., BANK OF AMERICA®), a third party financial services provider (e.g., PAYPAL®), a credit card company (e.g., VISA®) or the like. Although an example of an additional end 12c is described above, the system 10 is not limited to the above-identified additional end 12a-12c, and, as such, other ends may be included in the system 10.

Communication of information to/from the ends 12a-12c of the system 10 may include, but is not limited to an electronic communication of entered or selected data. The entered or selected data may be stored on, processed by, manipulated by, modified by, sent from, received by, or otherwise transmitted by a plurality of interconnected components 14 of the system 10.

The plurality of interconnected components 14 may include but are not limited to: one or more computers 14a, one or more modems/wireless routers 14b, one or more web servers 14c, one or more databases 14d, one or more application servers 14e including one or more processors 14e′ or the like. Although some of the plurality of interconnected components 14 are not shown at each end 12a-12c, it will be appreciated that some of the plurality of interconnected components 14 may be exclusive to a particular end 12a-12c, or, in the alternative, some of the plurality of interconnected components 14 may not be physically located in a similar location/building of a particular end 12a-12c and that some of the one or more computers 14a, the one or more modems/wireless routers 14b, the one or more web servers 14c, the one or more databases 14d and the one or more application servers 14e may be located remotely in a distributed fashion.

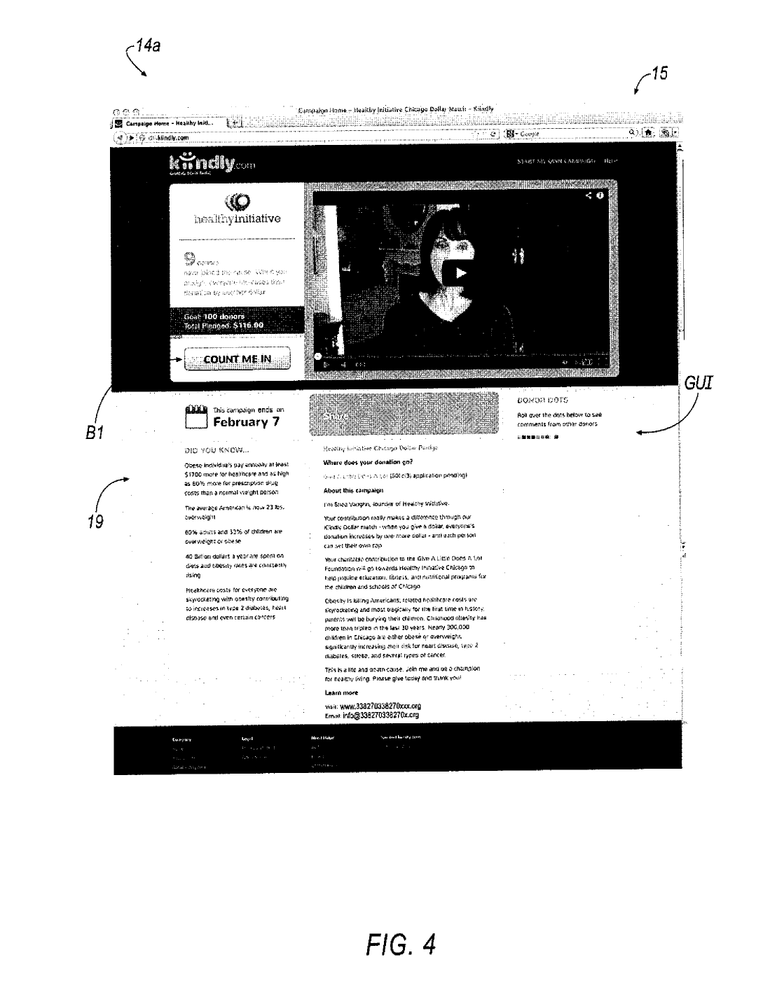

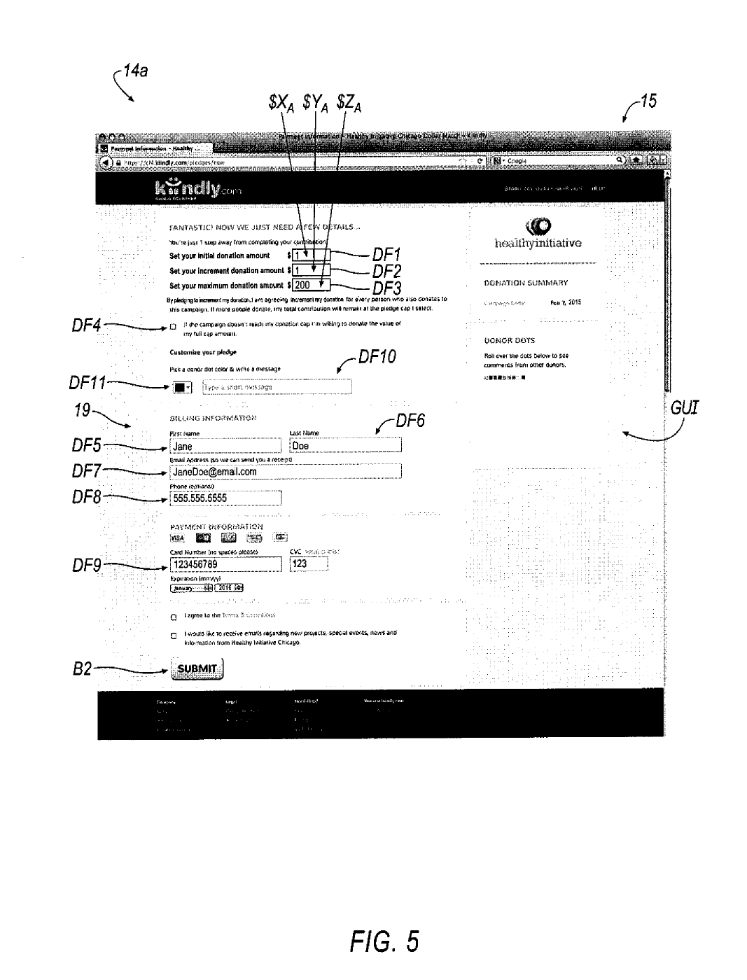

In an implementation, the one or more computers 14a include, but is/are not limited to: one or more computer workstations 14a′ (e.g., a desktop computer, a laptop computer or the like), one or more cell phones/smart-phones 14a″ (e.g., BLACKBERRY®, IPHONE® or the like), one or more tablet computers 14a″′ (e.g., IPAD® or the like) and/or one or more satellite phones 14a″″. In an implementation, each of the one or more computers 14a include a display that presents an image (such as, for example, a browser 15 including web-page content 19 as shown in, for example, FIGS. 4-5). Further, each of the one or more computers 14a include a human-interfacable means (e.g., a keyboard, mouse, touch-screen, microphone or the like) in order to permit, for example, a funder at the funder end 12b to enter/make selections/manipulate data associated with the image presented on the display of the one or more computers 14a. Although the one or more computers 14a are only shown at the funder end 12b in FIG. 1, it will be appreciated that one or more computers 14a may also be included at or otherwise associated with the provider end 12a, and/or the financial institution end 12c.

The ability of the ends 12a-12c to communicate with one another is enabled by one or more communication services/platforms 16. The one or more communication services/platforms 16 include but is/are not limited to: plain-old-telephone services (POTS) 16a, cellular services 16b, satellite services 16c, Internet access services 16d (including but not limited to: dial-up, landline [i.e., cable, optical fiber, twisted pairs], T-lines, Wi-Fi, cell phone), or, a hybrid/combination of two or more of the POTS 16a, cellular services 16b, satellite services 16c and Internet services 16d.

If, for example, access to Internet services 16d is requested during the operation of the system 10, the system 10 may be said to further include or otherwise cooperate with one or more Internet service providers (ISP) 18 that is/are connected to or otherwise in communication with the plurality of interconnected components 14. In an implementation, the one or more computers 14a of the plurality of interconnected components 14 may launch/utilize a browser 15 (e.g., INTERNET EXPLORER®, SAFARI®) as shown, for example, in FIGS. 4-5, that accesses and displays web-page content 19 (see also FIGS. 4-5) on the display of the one or more computers 14a.

The web-page content 19 is provided by the provider end 12a may include a graphical user interface, GUI, that enables the use of the virtual funding campaign methodology that is utilized by one or more funders at the funder end 12b. The logic and operation of the web-page content 19 is stored on/executed by/controlled by one or more of the web server 14c, database 14d and application server 14e at the provider end 12a. In an implementation, the funder at the funder end 12b may utilize a keyboard, mouse, touch-screen, microphone or the like of the one or more computers 14a in order to permit the funder at the funder end 12b to enter/make selections/manipulate data associated with the web-page content 19 presented on the display of the one or more computers 14a in order to permit the funder at the funder end 12b to utilize the virtual funding campaign methodology.

In an implementation, the word “virtual” in the context of the “virtual funding campaign methodology” may mean, but is not limited to being defined as: “being conducted on or simulated on a computer.” Accordingly, in an implementation, a funder at the funder end 12b may utilize the one or more computers 14a to manipulate, modify, send, receive, or otherwise transmit information electronically to other ends 12a, 12c of the system 10 in order to utilize the “virtual funding campaign methodology” provided by the provider end 12a. In another implementation, the word “virtual” in the context of “virtual funding campaign methodology” may mean, but is not limited to being defined as: “occurring or existing online via the Internet.”

Further, although an implementation of the system 10 may be said to be simulated on a computer 14a, and/or occurring or existing online via the Internet, operation of the system 10 may also be complemented by, for example, one or more living/live persons in/directly associated with the provider end 12a. The one or more living/live persons in/directly associated with the provider end 12a may assist (by way of, e.g., POTS, voice-over-Internet Protocol (VoIP)/chat point-to-point protocol (PPP)) one or more funders at the funder end 12b that utilize the virtual funding campaign methodology provided by the provider end 12a. It should be understood, however, that the one or more living/live persons in/directly associated with the provider end 12a are limited to, for example, providing “help desk services” or “trouble-shooting related services” pertaining to, for example, an issue related to the web-page content 19 and may not provide any form of services related to the virtual funding campaign methodology.

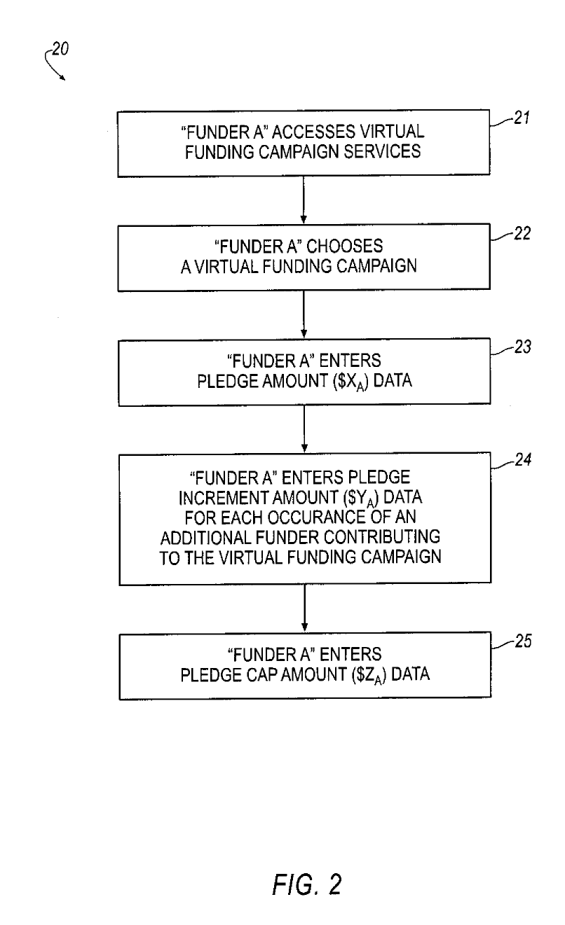

In an implementation, the phrase “fund” in relation to “funding” in the context of “virtual funding campaign methodology” may mean, but is not limited to being defined as: money. The act of providing funds (i.e., money) from one entity to another may be associated with a “pledge.” In an implementation, the phrase “pledge” may mean, but is not limited to being defined as “an amount of funds (i.e., money) that an entity has expressed a willingness to provide to another entity at a future time.” Execution of any form of the “pledge” associated with the virtual funding campaign methodology may include but is not limited to the provider end 12a utilizing a pledge module sub-processor 14e′ to track/tabulate one or more of, for example: a pledge amount (see, e.g., $X_{A}, in FIG. 2) in view of an increment pledge amount (see, e.g., $Y_{A}, in FIG. 2), a pledge cap amount (see, e.g., $Z_{A}, in FIG. 2) or the like.

Referring to FIG. 1, a general overview of an implementation of the system 10 is described. Firstly, according to an embodiment, a funding campaign coordinator may utilize the one or more computers 14a at, for example, the funder end 12b, in order to register a virtual funding campaign with the provider end 12a. The funding campaign coordinator may access the graphical user interface, GUI, from the public web-page content 19 from the provider end 12a for providing to the provider end 12a funding campaign data. The funding campaign data may be stored upon the database 14d at the provider end 12a. The funding campaign data may include one or more data entries including, for example: (1) the funding campaign coordinator's name, (2) the funding campaign coordinator's title, (3) the funding campaign coordinator's email address, (4) the funding campaign coordinator's phone number, (5) an organization name associated with the virtual funding campaign, (6) a text description of the purpose of the virtual funding campaign, (7) a video associated with the virtual funding campaign, (8) a funding goal amount, (9) a period of time that the virtual funding campaign will be active, or the like.

Once the funding campaign data is registered with the provider end 12a, the provider end 12a may utilize the funding campaign data to publish public web-page content 19 as seen, for example, in FIG. 4. As a result, one or more funders at the funder end 12b may utilize the one or more computers 14a to launch/utilize a browser 15 in order to access and display the public web-page content 19 as seen in, for example, FIG. 4. If the one or more funders at the funder end 12b wishes to participate in the virtual funding campaign, the one or more funders may select or “click on” a start button, B; as seen in FIG. 4, the start button, B1, may include the text “COUNT ME IN.”

Upon selecting/clicking on the start button, B1, a view of the graphical user interface, GUI, from the pubic web-page content 19 of FIG. 4 may change to that as shown in, for example, FIG. 5. As seen in FIG. 5, the graphical user interface, GUI, from the pubic web-page content 19 may include one or more pledge data fields, DF1-DF3. The one or more pledge data fields, DF1-DF3, permits the funder to enter, for example, pledge data, $X_{A}, $Y_{A}, $Z_{A}, in the one or more pledge data fields DF1-DF3; the entered pledge data, $X_{A}, $Y_{A}, $Z_{A}, may include, for example: pledge amount data, $X_{A}, increment pledge amount data, $Y_{A}, pledge cap amount data, $Z_{A}, or the like. As will be described in the following disclosure, the virtual funding campaign methodology provided by the provider end 12a utilizes the entered pledge data, $X_{A}, $Y_{A}, $Z_{A}, by the funder in order to tabulate a pledged funding amount for the funder.

Although three pledge data fields, DF1-DF3, are described above, it is contemplated that some implementations of the virtual funding campaign methodology may utilize less than the three pledge data fields, DF1-DF3. For example, one implementation of the virtual funding campaign methodology may be directed to: (1) a system-fixed pledge amount, (2) a system-fixed increment pledge amount and (3) a funder-entered pledge cap amount. Accordingly, in an implementation, the system-fixed pledge amount may be, for example, $1, and the system-fixed increment pledge amount may be, for example, $1. The funder-entered pledge cap amount may be any desirable amount that the funder chooses. Therefore, in such an implementation, the graphical user interface, GUI, from the pubic web-page content 19 of FIG. 4 may only include the data field, DF3, relating to the pledge cap amount data, $Z_{A}, whereas the data fields, DF1-DF2, are not included in the graphical user interface, GUI, from the pubic web-page content 19 of FIG. 4 due to the pledge amount data, $X_{A}, and the increment pledge amount data, $Y_{A}, being fixed by the system 10.

Because the system 10 may operate on the principle of funder-entered data in one or more data fields (e.g., DF1-DF3) and system-fixed data that is not manipulatable by the funder, the virtual funding campaign methodology may be carried out by “receiving” data and/or being “provided with”/“providing” data. Accordingly, irrespective of the pledge amount data, $X_{A}, being entered by the funder or fixed by the system 10, the pledge amount data, $X_{A}, may be said to be received or provided by/to the system 10. Therefore, in an example, when the pledge amount data, $X_{A}, is fixed by the system 10, the funder effectively authorizes/acquiesces to the fixed pledge amount data, $X_{A}, and, as a result, it may be said that the system 10 “receives” the fixed pledge amount data, $X_{A}, from the funder. In another example, when the pledge amount data, $X_{A}, is fixed by the system 10, the funder effectively authorizes/acquiesces to the fixed pledge amount data, $X_{A}, and, as a result, it may be said that the system 10 “provides” the fixed pledge amount data, $X_{A} (by virtual of acquiesced authorization by the funder). In yet another example, when the pledge amount data, $X_{A}, is entered by the funder, it may be said that the system 10 “receives” the fixed pledge amount data, $X_{A}, from the funder. In another example, when the pledge amount data, $X_{A}, is entered by the funder, it may be said that the funder “provides” the fixed pledge amount data, $X_{A}, to the system 10.

Referring to FIG. 2, an exemplary method 20 for initializing pledge data associated with a virtual funding campaign methodology is described. The method 20 firstly includes the step (see, e.g., step 21) of a funder (e.g., “Funder A”) utilizing the one or more computers 14a at, for example, the funder end 12b for launching/utilizing a browser 15 in order to access and display the graphical user interface, GUI, of the public web-page content 19 (as shown in, e.g., FIG. 4) including the funding campaign data from, for example, the web server 14c of the provider end 12a by way of, for example, the one or more communication services/platforms 16. Then, at step 22, the funder (e.g., “Funder A”) may utilize one or more computers 14a at, for example, the funder end 12b to select a virtual funding campaign displayed upon the graphical user interface, GUI, of the web-page content 19.

Upon selecting/clicking on the start button, B1, a view of the graphical user interface, GUI, from the pubic web-page content 19 of FIG. 4 may change to that as shown in, for example, FIG. 5. Then, at steps 23, 24 and 25, the funder (e.g., “Funder A”) may utilize one or more computers 14a at, for example, the funder end 12b to enter pledge data, $X_{A}, $Y_{A}, in one or more pledge data fields, DF1-DF3, displayed upon the graphical user interface, GUI, of the web-page content 19. For example, at step 23, the funder may enter a pledge amount data, $X_{A}, in a pledge amount data field (see, e.g., DF1 in FIG. 5). In another example, at step 24, the funder may enter a pledge increment amount data, $Y_{A}, in a pledge increment amount data field (see, e.g., DF2 in FIG. 5). In yet another example, at step 25, the funder may enter a pledge cap amount data, $Z_{A}, in a pledge cap amount data field (see, e.g., DF3 in FIG. 5). Once the pledge data, $X_{A}, $Y_{A}, $Z_{A}, is entered by the funder, the funder may select/“click on” a finish button, B2 (including the text, “SUBMIT”), in order to send the entered pledge data, $X_{A}, $Y_{A}, $Z_{A}, to the provider end 12a; after selecting/clicking on the finish button, B2, the funder may close the browser 15, thereby exiting the graphical user interface, GUI, of the web-page content 19.

The entered pledge data, $X_{A}, $Y_{A}, $Z_{A}, may be communicated from the funder end 12b to the provider end 12a by way of the one or more communication services/platforms 16. Once the entered pledge data, $X_{A}, $Y_{A}, $Z_{A}, arrives at the provider end 12b, the entered pledge data, $X_{A}, $Y_{A}, $Z_{A}, may be stored upon the database 14d of the provider end 12a. As will be described in the following methodology 30, the entered pledge data, $X_{A}, $Y_{A}, $Z_{A}, may be utilized by the virtual funding module processor 14e′ of the provider end 12a for tabulating a pledged funding amount for the funder (e.g., “Funder A”).

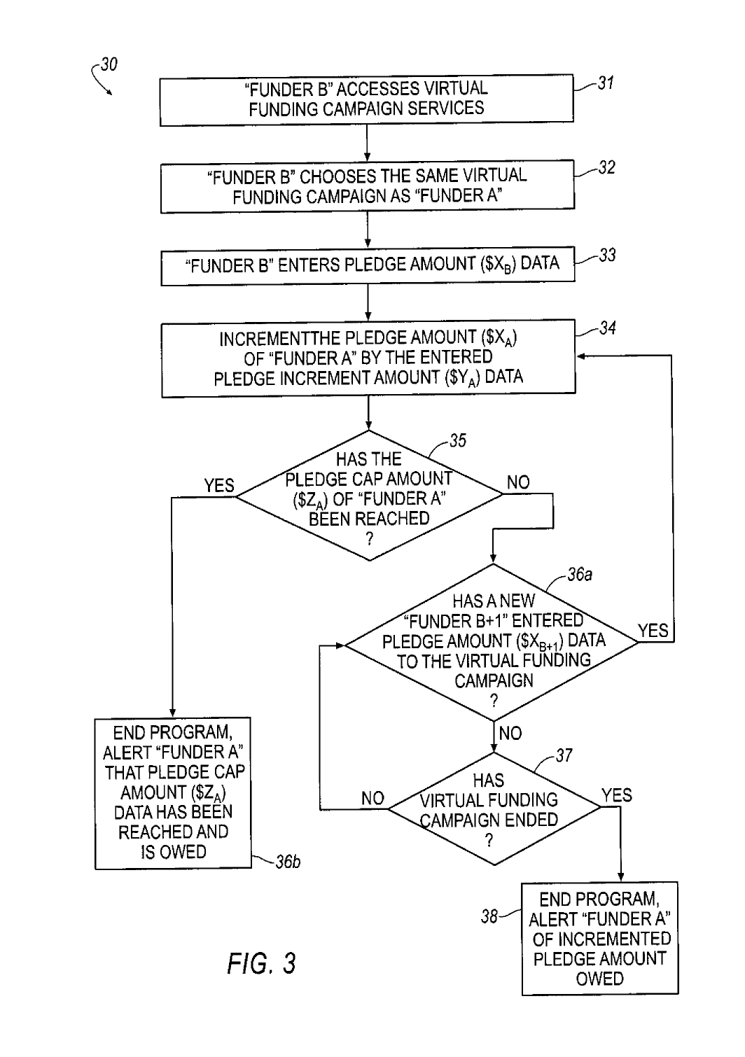

The virtual funding campaign methodology may operate on the principle of “compounding matching funders;” that is, a funder (e.g., “Funder A”) may act as a return contributor to the virtual funding campaign by provisionally agreeing to increase his/her pledged funding amount on the condition that other funders (e.g., “Funder B,” “Funder B+1,” etc., as seen in, e.g., FIG. 3) also participate in the virtual funding campaign. Accordingly, in an example as seen in, for example, FIG. 5, the funder (e.g., “Funder A”) may enter: (1) pledge amount data, $X_{A}, in an amount of, e.g., $1, (2), pledge increment amount data, $Y_{A}, in an amount of, e.g., $1, and (3) pledge cap amount data, $Z_{A}, in an amount of, e.g., $200.

In view of the above-entered exemplary dollar amounts of $X_{A}=$1, $Y_{A}=$1, $Z_{A}=$200, the funder (e.g., “Funder A”) is pledging an initial funding of $1 to the virtual funding campaign (by way of, e.g., $X_{A}=$1). When an additional funder (e.g., “Funder B”) pledges to the virtual funding campaign, the funder's pledge amount increments in the amount of $1 (by way of, e.g., $Y_{A}=$1). If, for example, further additional funders contribute to the virtual funding campaign, the funder (e.g., “Funder A”) is still further willing to permit the pledged amount to be incremented by $1 (by way of, e.g., $Y_{A}=$1) until the pledge cap amount of $200 is reached (by way of e.g., $Z_{A}=$200). Therefore, in order to reach the pledge cap amount of $200, the funder's funding criteria is that at least an additional 199 funders must pledge monetary support to the virtual funding campaign.

Although the virtual funding campaign methodology may operate on the principle of pledge cap amount data, $Z_{A}, the virtual funding campaign methodology may permit the funder (e.g., “Funder A”) to lift/remove the pledge cap amount data, $Z_{A}, at any time. For example, in an embodiment related to the above-identified scenario, should the number of additional funders exceed 199 persons, the system 10 may permit the funder to arbitrarily “write up” the tabulated pledge amount beyond the $200 pledge amount cap. In another example related to the above-identified scenario, should the number of additional funders fall short of 199 persons, the system 10 may permit the funder to arbitrarily “write up” the tabulated pledge amount to (or beyond) $200; in an example, this may be conducted by selecting/“clicking on” a check box funder data field, DF4. Next to the check box funder data field, DF4, the following text may be displayed “If the campaign doesn't reach my funding cap, I'm willing to provide the value of my full cap amount.” Accordingly, by selecting/clicking on the check box funder data field, DF4, the funder is agreeing to “write up” the tabulated pledge amount to $200 should the campaign fail to attract another 199 other funders to the campaign.

Referring to FIG. 3, an exemplary method 30 for conducting a virtual funding campaign methodology is described. The method 30 firstly includes the step (see, e.g., step 31) of another funder (e.g., “Funder B”) other than “Funder A” (described above at FIG. 2) utilizing the one or more computers 14a at, for example, the funder end 12b for launching/utilizing a browser 15 in order to access and display the graphical user interface, GUI, of the public web-page content 19 (as seen in, e.g., FIG. 4) including the funding campaign data from, for example, the web server 14c of the provider end 12a by way of, for example, the one or more communication services/platforms 16. Then, at step 32, the another funder (e.g., “Funder B”) may utilize one or more computers 14a at, for example, the funder end 12b to select the virtual funding campaign that was also selected by “Funder A.” Then, at step 33, the another funder (e.g., “Funder B”) may utilize one or more computers 14a at, for example, the funder end 12b to enter pledge data, $X_{B}, $Y_{B}, $Z_{B}, in one or more pledge data fields (see, e.g., DF1-DF3 in FIG. 5) displayed upon the graphical user interface, GUI, of the web-page content 19. For example, at step 33, the another funder may enter pledge amount data, $X_{B}, in the pledge amount data field (see, e.g., DF1 in FIG. 5).

As described above, the pledge module sub-processor 14e′ at the provider end 12a may track: the pledge amount (e.g., $X_{A}, $X_{B}) by funders (e.g., “Funder A,” “Funder B”), the increment pledge amount (e.g., $Y_{A}), and the pledge cap amount (e.g., $Z_{A}). At step 34, as a result of the another funder (i.e., “Funder B”) pledging a pledge amount (i.e., $X_{B}), the pledge module sub-processor 14e′ at the provider end 12a logically increments Funder A's pledge amount (i.e., $X_{A}) by the increment pledge amount (i.e., $Y_{A}).

Next, at step 35, the pledge module sub-processor 14e′ at the provider end 12a may determine if the pledge cap amount (e.g., $Z_{A}) of “Funder A” has been reached. In the event that the pledge cap amount (e.g., $Z_{A}) of the “Funder A” has not been reached, the method is advanced to step 36a where the pledge module sub-processor 14e′ at the provider end 12a may determine if yet another funder (e.g., “Funder B+1”) has utilized one or more computers 14a at, for example, the funder end 12b to enter pledge data (e.g., $X_{B+1}) in one or more pledge data fields, DF1-DF3, displayed upon the graphical user interface, GUI, of the web-page content 19 as seen in FIG. 5. If another funder (e.g., “Funder B+1”) has entered pledge data (e.g., $X_{B+1}) in the pledge amount data field (see, e.g., DF1 in FIG. 5), the method is looped from step 36a back to step 34 where the pledge module sub-processor 14e′ at the provider end 12a increments Funder A's pledge amount (i.e., $X_{A}) by the increment pledge amount (i.e., $Y_{A}).

However, if another funder (other than “Funder B”) has not entered pledge data, $X_{B+1}, $Y_{B+1}, $Z_{B+1}, the method is advanced from step 36a to step 37 where the pledge module sub-processor 14e′ at the provider end 12a may determine if period of time of the virtual funding campaign has ended. If the period of time of the virtual funding campaign has not ended, the method is looped from step 37 back to step 36a until anther funder (other than “Funder B”) has entered pledge data (e.g., $X_{B+1}) in the pledge amount data field (see, e.g., DF1 in FIG. 5).

If the period of time of the virtual funding campaign has ended, the method is advanced from step 37 to step 38. At step 38, the method may include the step of sending an alert (e.g., in the form of an email) to “Funder A” that the virtual funding campaign has ended and that a tabulated pledge amount (that is less than the pledge cap amount, $Z_{A}), is available for “Funder A's” review. The tabulated pledge amount (that is less than the pledge cap amount, $Z_{A}) may be stored in the database 14d at the provider end 12a.

Referring back to step 35, after several loops of the methodology at steps 36a to step 34, the pledge module sub-processor 14e′ at the provider end 12a may determine (at step 35) that the pledge cap amount (e.g., $Z_{A}) of “Funder A” has been reached. In the event that the pledge cap amount (e.g., $Z_{A}) has been reached, the method is advanced from step 35 to step 36b where the method may include the step of sending an alert (e.g., in the form of an email) to the funder (i.e., “Funder A”) that the pledge cap amount (e.g., $Z_{A}) has been reached and that a tabulated pledge amount equal to the pledge cap amount (e.g., $Z_{A}) is available for the funder's review. The tabulated pledge amount may be stored in the database 14d at the provider end 12a. Once the method 30 for conducting a virtual funding campaign methodology has been cycled and a tabulated pledge amount is made available for retrieval by the funder (e.g., “Funder A”) at the funder end 12b, “Funder A” may provide monetary funds to the funding campaign.

A transaction of monetary funds from the funder to the funding campaign may be conducted in a variety of methods. The desired method of transferring funds may be selected by “Funder A” at the time of entering the enter pledge data, $X_{A}, $Y_{A}, $Z_{A}, in one or more pledge data fields, DF1-DF3, displayed upon the graphical user interface, GUI, of the web-page content 19. For example, as seen in FIG. 5, the funder may enter: (1) first name data in a first name data field, DF5, (2) last name data in a last name data field, DF6, (3) email address data in an email address data field, DF7, (4) phone number data in a phone number data field, DF8 and (5) credit card data in a credit card data field, DF9. Although a credit card data field, DF9, for accepting credit card data is provided, the web-page content 19 is not limited to utilizing credit cards as a method for sending funds from the funder to the funder campaign. For example, the credit card data field, DF9, could alternatively be replaced with a bank account number and bank account routing number field. Alternatively, for example, the credit card data field, DF9, could alternatively be replaced with other financial account data related to, for example, a PAYPAL® account. Therefore, in an embodiment, the data field, DF9, may be broadly referred to as a “payment account data field.”

Once the provider end 12a is provided with at least data relating to the payment account data field, DF9, the provider end 12a may execute a movement of funds directly from the funder's payment account (located at, e.g., a credit card company, such as, for example, VISA®, a bank, such as, for example, BANK OF AMERICA®, a third party financial account, such as, for example, PAYPAL® or the like) to the funding campaign's financial account (located at, e.g., a bank, such as, for example, BANK OF AMERICA®, a third party financial account, such as, for example, PAYPAL® or the like); accordingly, in some implementations, the provider end 12a may also act as a broker that transfers funds from the funder to the funding campaign. The provider end 12a may conduct the brokered transaction by communicating with one or more web servers 14c located at the financial institution end 12c for initiating a request to move an amount of funds equal to the tabulated pledge amount from the funder's payment account to the funding campaign's financial account. Alternatively, should the funder not desire the provider end 12a to execute an automatic movement of funds as described above, the funder may, for example, write a check to the funding campaign in an amount equal to, for example, the tabulated pledge amount.

In some implementations, the provider end 12a may charge a fee to the funding campaign. The fee may be related to providing services to the funding campaign (i.e., the services being, e.g., one or more of publishing the web-page content 19 and moving the funds from the funder to the funding campaign).

In addition to the data fields DF1-DF9 described above, the graphical user interface, GUI, of the web-page content 19 may include other data fields. In an example, the other data fields may include, for example, a message field, DF10, and a funder identifier field, DF11. The message field, DF10, may include a personal message authored by the funder. The funder identifier field, DF11, may include a color selected from a pull-down button. When one or more funders enter a message and a select a color, a portion of the graphical user interface, GUI, of the web-page content 19 may generate a plurality of colored tiles. When a user hovers a cursor over one of the colored tiles, the message from the associated funder may be displayed in a pop-up window. The message may include, for example, a message of support or a reason why the funder decided to provide funds to the virtual funding campaign.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A virtual funding campaign method, comprising:
executing instructions on a computing processor to electronically display a graphical user interface;
receiving first pledge data of a first funder from at least one displayed field of the graphical user interface;
receiving additional pledge data from at least one second funder from the at least one displayed field of the graphical user interface;
modifying the first pledge data as a result of receiving the additional pledge data from the at least one second funder;
after the modifying step, tabulating a pledge amount for the first funder that is related to the modified first pledge data; and
electronically communicating the tabulated pledge amount of the first funder.

2. The method of claim 1 further comprising the step of:
electronically communicating cash handling instructions from a first funder financial account to a funding campaign financial account based on the tabulated pledge amount.

3. The method of claim 1, further comprising storing the first pledge data and the additional pledge data in memory.

4. The method of claim 3, further comprising retrieving first pledge data and the additional pledge data from memory to generate the tabulated pledge amount for the first funder.

5. The method of claim 1, wherein the first pledge data includes:
first pledge amount data.

6. The method of claim 5, wherein the first pledge data further includes:
pledge cap amount data.

7. The method of claim 6, wherein the modifying step includes
limiting an increase of the first pledge amount data to the pledge cap amount data as a result of receiving at least the additional pledge data from the at least one second funder.

8. The method of claim 5 further comprising:
providing pledge increment amount data.

9. The method of claim 8, wherein the modifying step includes
incrementing the first pledge amount data by the pledge increment amount data as a result of receiving the additional pledge data from the at least one second funder.

10. The method of claim 9, wherein the additional pledge data from the at least one second funder includes
pledge amount data.

11. A virtual funding campaign system comprising:
a graphical user interface having one or more fields displayed on an electronic display for
receiving first pledge data of a first funder from at least one displayed field of the graphical user interface,
receiving additional pledge data from at least one second funder from the at least one displayed field of the graphical user interface; and
a computing processor for:
modifying the first pledge data as a result of receiving the additional pledge data from the at least one second funder,
after the modifying step, tabulating a pledge amount for the first funder that is related to the modified first pledge data, and
electronically communicating the tabulated pledge amount of the first funder.

12. The system of claim 11, wherein the computing processor electronically communicates cash handling instructions from a first funder financial account to a funding campaign financial account based on the tabulated pledge amount.

13. The system of claim 11, further comprising:
memory that stores the first pledge data and the additional pledge data.

14. The system of claim 13, wherein the computing processor retrieves first pledge data and the additional pledge data from memory and generates the tabulated pledge amount for the first funder.

15. The system of claim 11, wherein the first pledge data includes:
first pledge amount data.

16. The system of claim 15, wherein the first pledge data further includes:
pledge cap amount data.

17. The system of claim 16, wherein the computing processor limits an increase of the first pledge amount data to the pledge cap amount data as a result of receiving at least the additional pledge data from the at least one second funder.

18. The system of claim 5 further comprising:
providing pledge increment amount data.

19. The system of claim 18, wherein the computing processor increments the first pledge amount data by the pledge increment amount data as a result of receiving the additional pledge data from the at least one second funder.

20. The system of claim 19, wherein the additional pledge data from the at least one second funder includes
pledge amount data.

21. A computer program product encoded on a non-transitory computer readable storage medium comprising instructions that when executed by a data processing apparatus cause the data processing apparatus to perform operations comprising:
executing instructions on a computing processor to electronically display a graphical user interface;
receiving first pledge data of a first funder from at least one displayed field of the graphical user interface;
receiving additional pledge data from at least one second funder from the at least one displayed field of the graphical user interface;
modifying the first pledge data as a result of receiving the additional pledge data from the at least one second funder;
after the modifying step, tabulating a pledge amount for the first funder that is related to the modified first pledge data; and
electronically communicating the tabulated pledge amount of the first funder.

22. The computer program product of claim 21 further comprising the step of:
electronically communicating cash handling instructions from a first funder financial account to a funding campaign financial account based on the tabulated pledge amount.

23. The computer program product of claim 21, further comprising storing the first pledge data and the additional pledge data in memory.

24. The computer program product of claim 23, further comprising retrieving first pledge data and the additional pledge data from memory to generate the tabulated pledge amount for the first funder.

25. The computer program product of claim 21, wherein the first pledge data includes:
first pledge amount data.

26. The computer program product of claim 25, wherein the first pledge data further includes:
pledge cap amount data.

27. The computer program product of claim 26, wherein the modifying step includes
limiting an increase of the first pledge amount data to the pledge cap amount data as a result of receiving at least the additional pledge data from the at least one second funder.

28. The computer program product of claim 25 further comprising:
providing pledge increment amount data.

29. The computer program product of claim 28, wherein the modifying step includes
incrementing the first pledge amount data by the pledge increment amount data as a result of receiving the additional pledge data from the at least one second funder.

30. The computer program product of claim 29, wherein the additional pledge data from the at least one second funder includes
pledge amount data.
